(19) United States
(12) Patent Application Publication
(10) Pub. No.: US 2007/0215786 A1
(43) Pub. Date: Sep. 20, 2007

(54) FORM BRACKET

(76) Inventor: Donald S. Nadler, Blue Springs, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/623,631

(22) Filed: Jan. 16, 2007

Related U.S. Application Data
(60) Provisional application No. 60/759,390, filed on Jan. 17, 2006.

(51) Int. Cl. B28B 7/22

(52) U.S. Cl. 249/163; 249/205

(57) ABSTRACT

A form bracket is provided. The bracket includes a central plate portion having tab portions and a receiver portion protruding from the central plate portion. Pieces of wood or other materials may be attached to the bracket at the tab portions and at the reciever.

This application claims priority pursuant to 35 U.S.C. 119(e) to co-pending U.S. Provisional Patent Application Ser. No. 60/759,390, filed Jan. 17, 2006, the entire disclosure of which is incorporated herein by reference.

### FIELD Of THE INVENTION

The present invention is directed generally to a bracket for positioning and anchoring forms for use in producing structural concrete members.

### BACKGROUND OF INVENTION

Tilt-up concrete construction relies on the pouring of structural concrete members, such as walls, wall panels, and the like, at the construction job site. The structural concrete member is generally outlined by one or more concrete forms set up across a horizontal surface such that the concrete member will be laying flat after pouring. Once the concrete is poured into the form and allowed to set, the structure is tilted up and into place in the overall construction. A releasing agent in the concrete allows for the ready removal of the form after the concrete member has been tilted into position.

In order to produce the appropriate concrete structure, the form used must be maintained in the proper position at all times during the production of the concrete member. Typically, a 2×6 or other portion of wood is used to produce the form. In order to prevent the form from moving out of position during the pouring of concrete, a support is placed alongside the form and anchored into the floor upon which the form is being poured. Typical supports of this type consist of pieces of wood nailed or otherwise attached to form the correct support structure. The wood can then be anchored to the concrete floor in the correct position such that the form can be nailed thereto and held in place.

Using makeshift wooden supports to hold a form in place can be time consuming due to the need to produce the support, may be prone to error inherent to the process of making the support, and results in a support that has limited uses before being too full of holes from nails, screws and the like to be of further value. What is needed, therefore, is a sturdy, reusable device for correctly positioning a concrete form.

### SUMMARY OF INVENTION

The present invention comprises a bracket for positioning and anchoring a concrete form. The inventive device includes a central plate portion extending along a vertical plane. A first side of the plate includes at least one tab portion, either attached such as, for example, by welding, or formed as an integral part thereof. A second side of the plate includes a receiving portion adapted to receive a portion of wood or other material therein. This receiving portion may also be welded to the plate portion, or otherwise attached thereto, or formed as an integral portion thereof.

Two portions of wood are preferably used in conjunction with the inventive bracket, a first portion of wood being positioned horizontally beneath the at least one tab portion and attached to the bracket via a nail, screw, or other devices through a hole in the tab portion. A second portion of wood is positioned vertically along a height of the plate portion and set within the receiving portion of the bracket. The second portion of wood is attached to the bracket via nails, screws, or other device through holes in the plate portion and receiving portion. The edges of both portions of wood are flush with the edge of the plate portion of the bracket.

In use, the inventive bracket is positioned with a concrete form positioned along one side of the bracket such that a surface of the form is flush with the ends/edges of the two portions of wood and an edge of the plate of the bracket. An anchor is preferably inserted through the first portion of wood and into the concrete floor in order to hold the bracket in place. The concrete form is then preferably nailed into at least one of the two wood portions associated with the now-anchored bracket, thereby holding the form in place as well. Multiple of the inventive brackets are preferably used, each being spaced apart as necessary to provide adequate support to the concrete form. Once the concrete form is in place, the structural concrete member may be formed.

The present bracket is preferably constructed of steel, though any suitable material may be used. The design and construction of the present device make it susceptible to numerous and repeated use, and allow for easy standardized manufacture of multiple such brackets, each having the same specifications. In place of the two wood portions, other materials, such as, for example, polymers, may be used.

Though the present invention is adapted for use in positioning concrete forms, it is contemplated that the device may be adapted to other uses whereby wood or other material is desired to be anchored to a concrete slab. For example, the present device may be used for the formation of handrails along concrete structures at construction job sites. In such case, the device is preferably positioned upon a concrete floor, slab, or other surface with two wood portions included. The second wood portion, being the vertically-extending portion, preferably extends upwardly to a height that is useful for the purpose of forming a handrail post/support and a cross-member is connected between two or more posts to form a handrail. Multiple brackets are preferably used, spaced apart as needed. The vertical wood portions may be connected by additional portions of wood, or by cables or any other suitable method such that a railing is formed.

One non-limiting example of how the present bracket may be anchored is provided in U.S. patent application Ser. No. 10/988,998, which is hereby incorporated into this disclosure by reference.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF DRAWING

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a right side frontal perspective view of a form bracket of one preferred embodiment of the instant invention.

FIG. 2 is a right side plan view of the form bracket shown in FIG. 1.

FIG. 3 is a rear end plan view of the form bracket shown in FIG. 1.

FIG. 4 is a top elevation view of the form bracket shown in FIG. 1.

FIG. 5 is a left side plan view of the form bracket shown in FIG. 1.

FIG. 6 is a right side rear perspective view of the form bracket shown in FIG. 1 in use with a pair of two by fours.

FIG. 7 is a right side plan view of several of the form brackets shown in FIG. 1 in use as a railing.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

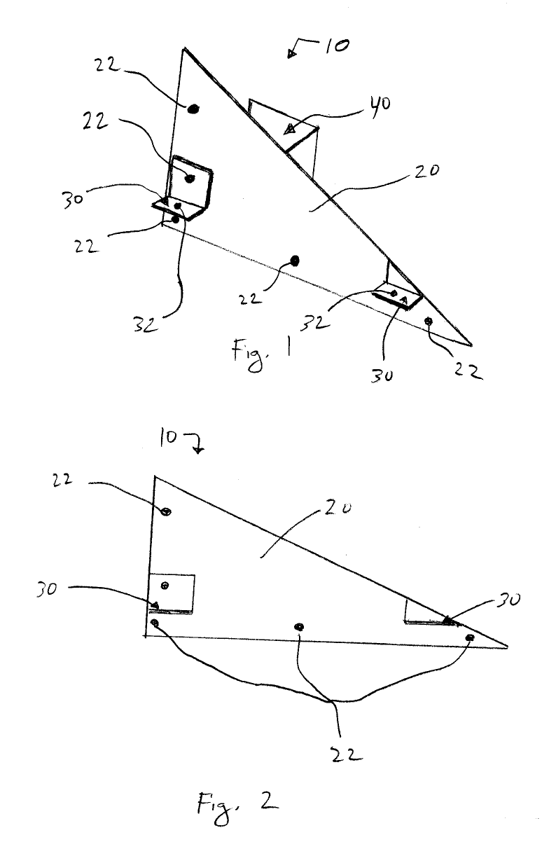

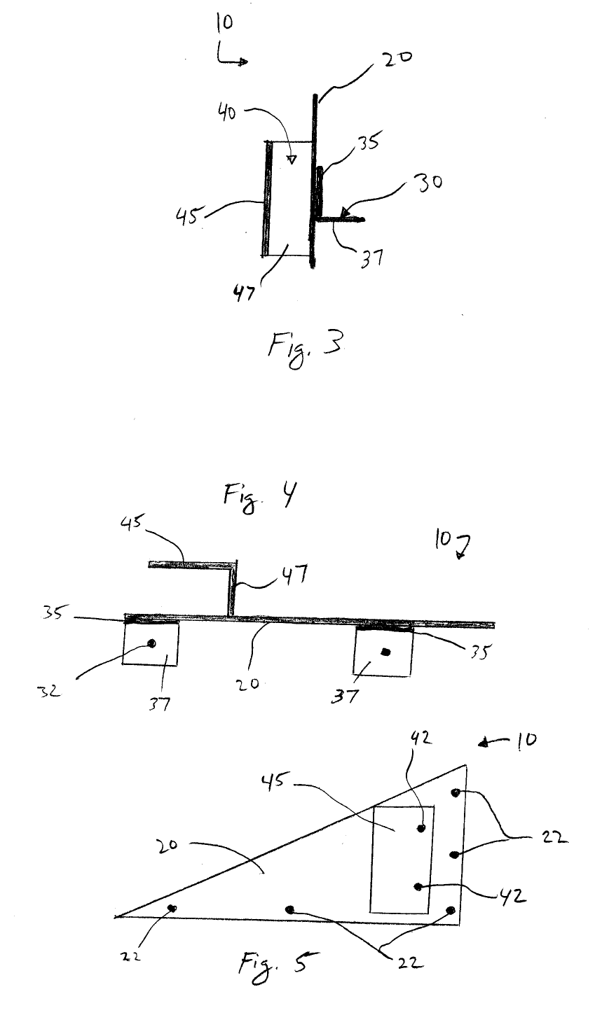

Referring to FIGS. 1 through 5, bracket 10 of the instant invention includes central plate portion 20 extending generally along a vertical plane, tab portions 30 protruding from plate portion 20 on a first (right, as shown in FIGS. 1 through 5) side, and receiver portion 40 protruding from plate portion 20 on a second (left, as shown in FIGS. 1 through 5) side.

In the embodiment shown in FIGS. 1 through 5, tab portions 30 are angled pieces (such as pieces of angle-iron) made up of vertical member 35 and horizontal member 37. Vertical member 35 is welded or otherwise attached to central plate 20 such that vertical member 35 is parallel to and flush against central plate 20. Horizontal member 37 protrudes generally perpendicular (horizontal) to vertical member 35 and central plate 20. Receiver portion 40 is also an angle piece (such as a piece of angle-iron). Perpendicular member 47 of receiver portion is welded or otherwise attached at its end to central plate 20 such that perpendicular member 47 protrudes generally orthogonally from central plate 20. Parallel member 45 extends generally orthogonally from perpendicular member 47 such that parallel member is generally parallel to central plate 20. As is shown, parallel member 45 is spaced apart from central plate 20 to create a receiver pocket formed by parallel member 45, perpendicular member 47 and central plate 20, adapted to receive a portion of wood or other material therein.

In a preferred embodiment, bracket 10 of the instant invention includes a plurality of holes pre-formed, drilled, or otherwise extending through bracket 10 to allow wood or other suitable materials/objects to be attached to bracket 10 with screws, nails, or other anchors. In the embodiment shown in FIGS. 1-5, bracket 10 includes holes 22 extending horizontally through central plate 20, holes 32 extending vertically through horizontal member 37 of tab portions 30, and holes 42 extending horizontally through parallel member 45 of receiver portion 40.

Referring to FIG. 6, use of bracket 10 is shown. Two portions of wood (such as pieces of a 2×4) are preferably used in conjunction with bracket 10, with first wood portion 110 being positioned horizontally beneath tab portions 30 and attached to bracket 10 via a nail, screw, or other devices through holes 32 in tab portions 30 and through some of holes 22 in plate portion 20. Second wood portion 100 is positioned vertically along the height of plate portion 20 and set within the pocket of receiving portion 40 of bracket 10. Second wood 100 is attached to the bracket via nails, screws, or other device through holes 42 in receiver portion 40 and through some of holes 22 in plate portion 20. The edges of both portions of wood are flush with the rear edge of plate portion 20 of bracket 10 as is shown in FIG. 6. The bottom of first wood portion 110 is also flush with the bottom of second wood portion 100, so that the bracket will sit flush on the ground.

In use, once wood portions 100 and 110 are attached to bracket 10, the rear side of bracket 10 (as shown in FIG. 6—i.e. the flush edges of wood portions 100 and 110) is positioned against a concrete form such that a surface of the form is flush with the rear edges of two portions of wood and the rear edge of plate portion 20. One or more anchors is then preferably inserted through first wood portion 110 and into the concrete floor in order to hold bracket 10 in place. The concrete form is then preferably nailed into at least one of wood portions 110 and 100 of anchored bracket 10, thereby holding the form in place as well. Multiple of brackets 10 are preferably used, each being spaced apart as necessary to provide adequate support to the concrete form. Once the concrete form is in place, the structural concrete member may be formed/poured.

Bracket 10 is preferably constructed of steel, though any suitable material may be used. The design and construction of the present device make it susceptible to numerous and repeated use, and allow for easy standardized manufacture of multiple such brackets, each having the same specifications. In place of the two wood portions, other materials, such as, for example, polymers, may be used. In addition, it will be appreciated that the size and arrangement of tab portions 30, receiver portion 40 and holes 22, 32, and 42 may vary depending upon the material to which bracket 10 is to be attached. For purposes of example only, it will be appreciated that horizontal members 37 of tab portions 30 may be positioned to be flush with the bottom of plate member 20 such that bracket 10 may be anchored to the floor without the use of wood portion 110.

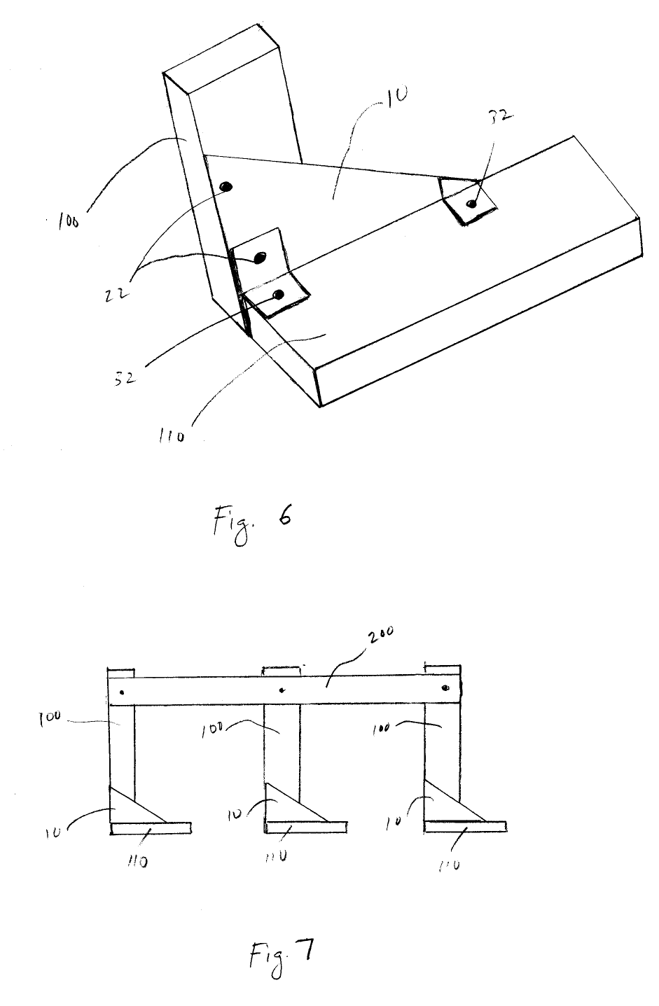

Though the bracket of the present invention is adapted for use in positioning concrete forms, it is contemplated that the device may be adapted to other uses whereby wood or other material are desired to be anchored to a concrete slab or to other materials. For example, as shown in FIG. 7, bracket 10 may be used for the formation of handrails along concrete structures at construction job sites. In such case, brackets 10 are preferably positioned upon a concrete floor, slab, or other surface as shown in FIG. 7, with two wood portions 100 and 110 already attached in the manner described above. Second wood portion 100 for each bracket preferably extends upwardly to a height that is useful for the purpose of forming a handrail. Multiple brackets 10 are preferably used, spaced apart as needed. The vertical wood portions (100) are be connected together by wood cross-member 200 which is nailed, screwed, or otherwise anchored to wood portions 100. It will be appreciated that cables or any other materials may be used in place of cross-member 200 to form the handrail.

One non-limiting example of how the present bracket may be anchored to the concrete slab is provided in U.S. patent application Ser. No. 10/988,998, which is hereby incorporated into this disclosure by reference. As is discussed in more detail in 10/988,998, a hole is drilled through wood portion 110 and into the concrete slab on which it is placed, a nail is then driven into the hole to anchor wood portion 110 to the slab. When it is desired to remove the bracket, the nail is removed.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A form bracket comprising:
a central plate; and
at least on tab protruding from a first side of said plate.

2. The form bracket as claimed in claim 1 further comprising a receiver protruding from a second side of said plate.

3. The form bracket as claimed in claim 2 wherein said receiver comprises a perpendicular member protruding from said plate and a parallel member spaced apart from and parallel to said plate.

4. The form bracket as claimed in claim 3 wherein said parallel member includes at least on hole extending therethrough.

5. The form bracket as claimed in claim 1 wherein said at least one tab comprises at least two tabs.

6. The form bracket as claimed in claim 1 wherein said tab includes at least one hole extending therethrough.

7. The form bracket as claimed in claim 1 wherein said tab comprises a vertical member attached to said plate and a horizontal member protruding from said vertical member.

8. The form bracket as claimed in claim 1 wherein said plate includes at least one hole extending therethrough.

9. The form bracket as claimed in claim 1 wherein the form bracket is constructed of steel.

10. A form bracket comprising:
a central plate;
at least on tab protruding from a first side of said plate; and
a receiver protruding from a second side of said plate.

11. The form bracket as claimed in claim 10 wherein said receiver comprises a perpendicular member protruding from said plate and a parallel member spaced apart from and parallel to said plate.

12. The form bracket as claimed in claim 11 wherein said parallel member includes at least on hole extending therethrough.

13. The form bracket as claimed in claim 10 wherein said at least one tab comprises at least two tabs.

14. The form bracket as claimed in claim 10 wherein said tab includes at least one hole extending therethrough.

15. The form bracket as claimed in claim 10 wherein said tab comprises a vertical member attached to said plate and a horizontal member protruding from said vertical member.

16. The form bracket as claimed in claim 10 wherein said plate includes at least one hole extending therethrough.
